(19) United States
(12) Patent Application Publication
(10) Pub. No.: US 2020/0390642 A1
(43) Pub. Date: Dec. 17, 2020

(54) SKIN CARE DEVICE

(71) Applicant: K CO., LTD., Hwaseong-si (KR)

(72) Inventors: Jung Rack KIM, Hwaseong-si (KR); Dong Hoo KIM, Osan-si (KR); Ji An KIM, Gwacheon-si (KR)

(73) Assignee: K CO., LTD., Hwaseong-si (KR)

(21) Appl. No.: 16/902,206

(22) Filed: Jun. 15, 2020

(30) Foreign Application Priority Data
Jun. 13, 2019 (KR) 10-2019-0070011

(51) Int. Cl. A61H 15/00; A61H 15/02

(52) U.S. Cl. CPC A61H 15/0092; A61H 15/02; A61H 2205/022; A61H 2205/021; A61H 2015/0014

(57) ABSTRACT

A skin care device includes: a handle provided with a first pressurizing supporter and a second pressurizing supporter, and a pressure force acting in a direction to approach each other according to a gap between the first pressurizing supporter and the second pressurizing supporter; a first massager provided at an end of the first pressurizing supporter and having a pair of massage rollers that massage the skin as the handle is moved while in contact with the skin; a second massager provided at an end of the second pressurizing supporter and having a pair of massage rollers that massage the skin as the handle is moved while in contact with the skin; and a controller configured to control providing a radio-frequency electrical stimulation to the skin contacted through the pair of massage rollers provided by each of the first massager and the second massager.

### BACKGROUND OF THE INVENTION

### Field of the Invention

The present invention relates to a skin care device, and more specifically, the skin care device according to the present invention prevents skin aging and improves skin elasticity by simultaneously providing massage and radio-frequency electrical stimulation to the skin of the face, body, etc.

### Description of the Related Art

In general, as a person's skin ages, elasticity decreases and the skin stretches and wrinkles, and when exposed to UV light for a long time, the skin becomes thicker and the skin's blood circulation ability decreases, and moisture and nutrients are not supplied smoothly to the skin.

In order to solve this problem, a functional substance such as a nourishing cream has been applied to a skin, or a skin massage method for providing a physical stimulation to the skin has been used to further facilitate blood circulation.

In addition, it is already known that the radio-frequency electric stimulation of the skin promotes absorption of nutrients applied to the skin and promotes blood circulation by generating deep heat in the skin.

Recently, as interest in skin beauty has increased significantly, the development of a skin beauty device that improves the skin elasticity and prevents aging by simultaneously providing massage and radio-frequency electric stimulation for the skin has been actively conducted.

As described above, a number of prior art documents related to a skin beauty device to simultaneously provide massage and radio-frequency electric stimulation for the skin have been published, Korean patent application Nos. 10-2018-7002938, 10-2015-0111040, 10-2017-7027957, 10-2017-0122435.

Prior arts as described above providing technologies for skin care devices, while massage balls is in contact with the skin, as the user moves the handle up and down, the massage ball physically stimulates the skin, that is, while performing the massage, electric stimulation is applied to the skin through the massage balls.

However, since the prior art as described above provides electrical stimulation while massaging only one side of the skin such as a side of a face although it is necessary to provide electrical stimulation and massaging to both sides of the face such as both sides of cheeks or jaw, there was a problem that prior arts of skin care devices was not suitable for the above stated case.

That is, the prior arts of skin care device as described above was not suitable to use on a user's face because in the case of the face, the skin on the left and right sides can be treated at the same time to obtain a good effect, whereas care for only one side of the face is less effective.

In addition, it is necessary to be controlled so that the electrical stimulation is limited only when the skin care device is used in contact with the skin in that radio-frequency electrical stimulation is applied to the skin. However, the prior arts of skin care device was quite insufficient in the aspect of a function for safety as stated above.

### SUMMARY OF THE INVENTION

The present invention is to solve the problems of the prior arts as described above and to achieve a more effective skin beauty effect, in particular, by providing physical massage and electrical stimulation simultaneously on both sides along the face line such as both sides of cheeks or jaw. The present invention is to provide a skin care device that can obtain the effect of skin improvement, that is, more suitable for skin care for the face.

In accordance with one aspect of the present invention, the above and other objects can be accomplished by the provision of a skin care device including a first pressurizing supporter and a second pressurizing supporter, and a handle to apply a pressing force in a direction to approach each other according to the gap between the first pressurizing supporter and the second pressurizing supporter; A first massager provided at an end of the first pressurizing supporter and having a pair of massage rollers that massage the skin as the handle is moved while in contact with the skin; A second massager provided at an end of the second pressurizing supporter and having a pair of massage rollers that massage the skin as the handle is moved while in contact with the skin; and a controller that controls providing a radio-frequency electrical stimulation to the skin contacted through a pair of massage rollers provided by each of the first massager and the second massager.

The skin care device according to the present invention can obtain a more advantageous effect of skin improvement using a handle provided with a pair of pressurizing supporters, and a massager provided at the end of each pressurizing supporter, in particular, physically massaging and providing electrical stimulation on both sides simultaneously along the face line such as both sides of cheeks and jawline.

### BRIEF DESCRIPTION OF THE DRAWINGS

FIG. 1 shows a configuration and an operation of the skin care device according to an embodiment of the present invention.

FIG. 2 shows an example of using the skin care device shown in FIG. 1 on a user's face.

FIG. 3 shows a skin care device in which a configuration of a rotating detector that detects rotation of a massage roller is added to the configuration shown in FIG. 1.

FIG. 4 shows a skin care device in which a configuration of a pressure detector for sensing pressure when a distance between a first pressurizing supporter and a second pressurizing supporter are increasing is added to the configuration shown in FIG. 1.

FIG. 5 is an exploded perspective view showing a configuration of a massager of a skin care device according to an embodiment of the present invention.

FIG. 6 shows a plan view (a) of the coupled state of the massager shown in FIG. 5, and a front view (b) of the coupled state of the massager shown in FIG. 5.

FIG. 7 shows a top view (a) illustrating an operation of the massager of the skin care device according to an embodiment of the present invention, and a front view (b) illustrating the operation of the massager shown in FIG. 7(a).

FIG. 8 shows various specific examples of the rotating detector described with reference to FIG. 3.

FIGS. 9 and 10 are views showing various specific examples of the pressure detector described with reference to FIG. 4.

FIG. 11 is a view for explaining a skin contact detector used in the skin care device according to an embodiment of the present invention.

FIGS. 12 and 13 are views showing the configuration and operation state of a skin care device according to another embodiment of the present invention.

FIG. 14 shows an enlarged view (a) of a main part when the skin care device is in a normal state corresponding to FIG. 13(a), and an enlarged view (b) of the main parts of the skin care device when the pressurizing supporters are broaden from each other corresponding to FIG. 13(b).

FIG. 15 is an enlarged view showing a main component of a skin care device according to another embodiment of the present invention.

FIG. 16 shows a configuration related to control of a skin care device according to another embodiment of the present invention.

FIG. 17 is an exploded perspective view showing the configuration of a massager of a skin care device according to another embodiment of the present invention.

FIG. 18 shows a plan view (a) of the coupled state of the massager shown in FIG. 17, and a front view (b) of the coupled state of the massager shown in FIG. 17.

FIG. 19 shows an exploded perspective view (a) illustrating the configuration of one of the massage roller shown in FIG. 17, and a cross-sectional view (b) illustrating an I-I section shown in FIG. 19(a).

### DETAILED DESCRIPTION

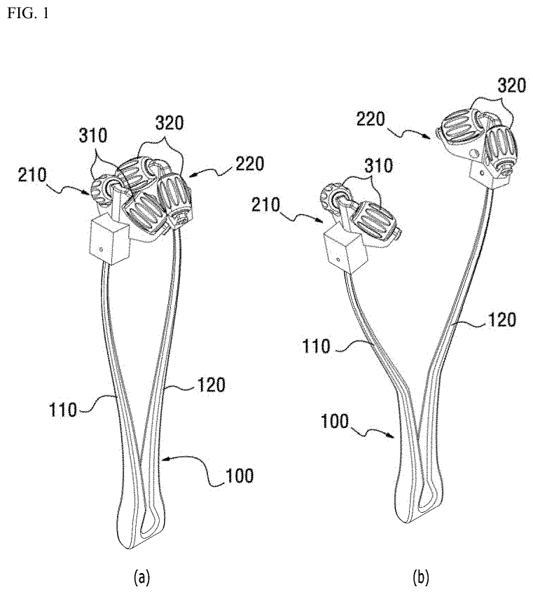

As shown in FIG. 1, the skin care device according to an embodiment of the present invention includes a handle 100 having a first pressurizing supporter 110 and a second pressurizing supporter 120, a first massager 210 provided at an end of the first pressurizing supporter 110 and a second massager 220 provided at end of the second pressurizing supporter 120, and a controller.

As shown in FIG. 1, the handle 100 includes a first pressurizing supporter 110 and a second pressurizing supporter 120, and corresponds to an entire frame or a body of the skin care device according to the present invention. When a gap between the first pressurizing supporter 110 and the second pressurizing supporter 120 is broaden as shown from a state of FIG. 1(a) to a state of FIG. 1(b), pressure acts in a direction to approach each other.

The first massager 210 is provided at the end of the first pressurizing supporter 110 as shown in FIG. 1, the second massager 220 is provided at the end of the second pressurizing supporter 120, and a pair of massage rollers 310 and 320 are provided to each of the first massager 210 and the second massager 220.

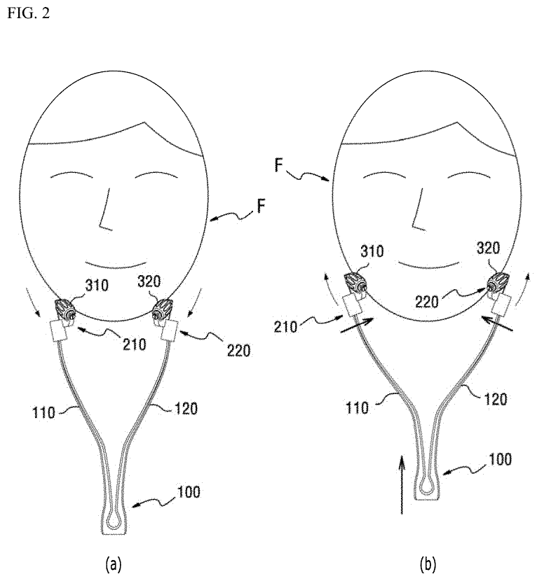

Thus, as shown in FIG. 2, the user broads between the first pressurizing supporter 110 and the second pressurizing supporter 120 of the skin care device according to the present invention, positions the skin part such as the user's face therebetween, and massaging on the skin can be performed by rolling a pair of massage rollers 310 of the first massager 210 and another pair of massage rollers 320 of the second massager 220 as the user grasps the handle 100 and moves it up and down while the first massager 210 and the second massager 220 are in close contact with the skin area at the same time.

Wherein, the first massager 210 and the second massager 220 are respectively connected to a controller, the controller is connected to a radio-frequency generator, and the controller controls the radio-frequency generator to provide radio-frequency electrical stimulation to the skin contacted through the pairs of massage rollers 310 and 320 provided at the first massager 210 and the second massager 220.

That is, when the user holds the handle 100 and moves the skin care device up and down, the state shown in FIG. 2(a) goes to the state shown in FIG. 2(b) and again to the state shown in FIG. 2(a), the skin care device according to the present invention can be used by iterating in such a way.

When the first pressurizing supporter 110 and the second pressurizing supporter 120 are broaden between each other such that the pair of massage rollers 310 of the first massager 210 are in contact with one side of the face and the pair of massage rollers 320 of the second massager 220 are in contact with the other side of the face, skin massage is performed while moving in close contact with both sides of the face at the same time in the state that the pair of massage rollers 310 of the first massager 210 and the pair of massage rollers 320 of the second massager 220 by pressure acting on the first pressurizing supporter 110 and second pressurizing supporter 120.

The pair of massage rollers 310 and 320 may be made of a metal material or have a metal plating, so that radio-frequency current can be passed.

In case that the pairs of massage rollers 310 and 320 provided by each of the first massager 210 and the second massager 220 are in contact with the skin, or in case of skin massage while rotating in accordance with the movement of the handle 100 in contact with the skin, the controller provides radio-frequency electrical stimulation to the skin through the pairs of massage rollers 310 and 320 of each massager, and when the pairs of massage rollers 310 and 320 do not contact or rotate the skin, the controller can control to block the provision of electrical stimulation, so as to prevent the risk of electric shock and improve safety.

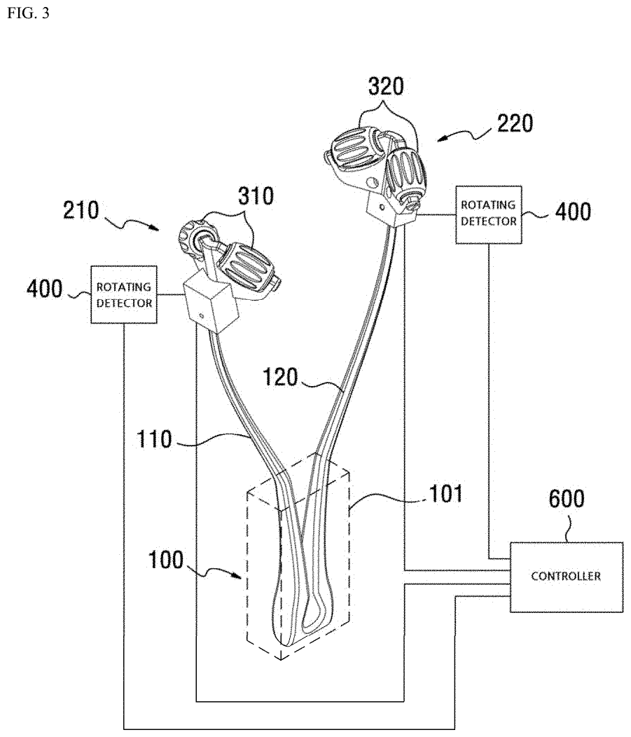

As a means for improving safety as described above, the skin care device according to an embodiment of the present invention may include a rotating detector 400 configured to detect whether the massage rollers 310 and 320 rotate, or to detect a rotational speed of the massage rollers 310 and 320 as shown in FIG. 3. A more specific example of the rotating detector 400 will be described later.

When using the skin care device according to the present invention in a state in which the rotating detector 400 is provided as described above, the controller 600 can control to provide radio-frequency electrical stimulation while the pair of massage rollers 310 and 320 of each of the massagers 210 and 220 rotate according to a detection result of the rotating detector 400. Or the controller 600 may control to calculate a rotational speed of the pair of massage rollers 310 and 320 according to the detection result of the rotating detector 400 and provide radio-frequency electrical stimulation according to the calculated rotational speed.

In this case, when the user does not use the skin care device according to the purpose of use, for example, when playing with the skin care device, the controller 600 blocks to provide radio-frequency electric stimulation to prevent a user from being shocked by radio-frequency current when the pair of massage rollers 310 and 320 on each massager 400 are not rotated or the calculated rotational speed does not reach a preset value.

The rotating detector 400 may be provided on only one of the two massagers 210 and 220 and may be provided on both sides.

Even if the above-described rotating detector 400 is provided on each of the massagers 210 and 220 on both sides, the controller 600 may control the radio-frequency electricity not receiving detection signals from both rotating detectors 400 provided on both massagers at the same time but receiving detection signal from only one rotating detector 400.

The controller 600 controls to stop generating the radio-frequency electricity when an abnormality is detected in the detection signal received from at least one of the rotating detectors 400.

Otherwise, the controller 600 controls to stop receiving the detection signal from the rotating detector 400 when an abnormality is detected in the detection signal received from that rotating detector 400, and generate the radio-frequency electricity according to receiving the detection signal from the other rotating detector.

That is, only one of the rotating detectors is activated and the other is deactivated, and the deactivated rotating detector can be preliminarily used when the activated rotating detector malfunctions.

Meanwhile, the skin care device according to an embodiment of the present invention includes a pressure sensor 500 as a means for improving safety.

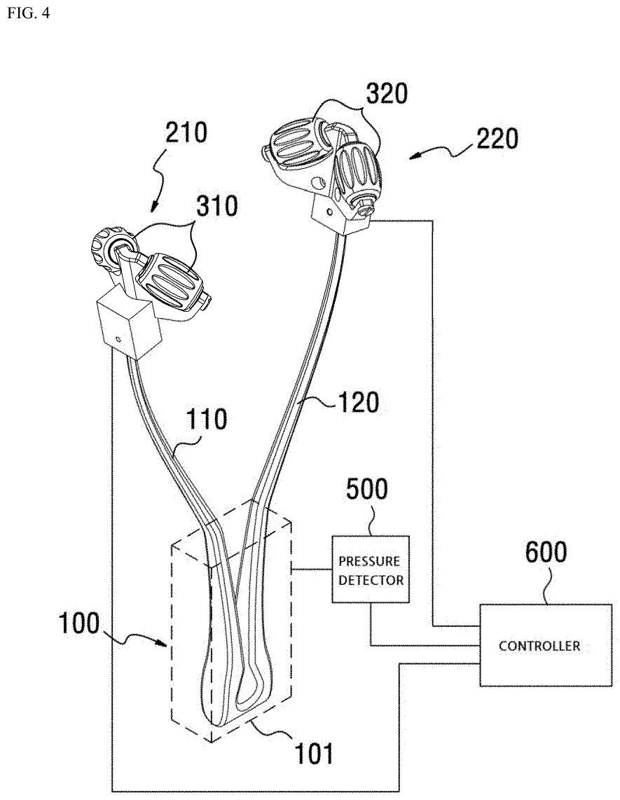

As shown in FIG. 4, the pressure sensor 500 may be provided between the first pressurizing supporter 110 and second pressurizing supporter 120, and detect whether the first pressurizing supporter 110 and the second pressurizing supporter 120 are broaden. A more specific example of the pressure detector 500 will be described later.

When the skin care device according to the present invention is used in the state in which the pressure detector 500 is provided, the controller 600 may control to provide the radio-frequency electrical stimulation in a case that the state in which the first pressurizing supporter 110 and the second pressurizing supporter 120 are broaden lasts for a predetermined time.

That is, as the first pressurizing supporter 110 and the second pressurizing supporter 120 are broaden, when the pressure detector 500 detects a pressure value in a preset range and the sensed pressure value in the preset range maintains for a preset time, the controller may determine that the user is using the skin care device according to the present invention and apply a radio-frequency current to each of the massagers 210 and 220. When the user simply touches the skin care device without using it for skin care, the controller can prevent the risk of electric shock caused by blocking the radio-frequency current the application of the radio-frequency current.

As described above, the skin care device according to the present invention is provided with a rotating detector 400 and a pressure sensor 500 for the purpose of improving safety, such as prevention of electric shock risk, but also has a great effect in terms of improvement for user convenience.

That is, without the user's inconvenience such as continuously pressing a separate button or switch during skin massage so as to transmit radio-frequency electric stimulation to the skin while the controller is turned on in order to use the skin care device, if the user normally uses the skin care device according to the present invention, the radio-frequency electric stimulation is automatically transmitted by the detection of the rotating detector 400 or the pressure sensor 500, and as the user stops the use of the skin care device, the transmission of radio-frequency electrical stimuli is blocked, which can greatly improve the user's convenience.

Meanwhile, as shown in FIGS. 3 and 4, the skin care device according to the present invention may be configured by casing the handle body 101 to the handle 100.

The pressure sensor 500 may be mounted inside the handle body 101, or the controller 600 may be configured to be separately connected to the handle body 101 and connected to a wire to use the controller 600. It is also possible to implement the skin care device according to the present invention in a wireless manner by configuring it to be embedded in the handle body 101 and allowing a charging battery or the like to be embedded.

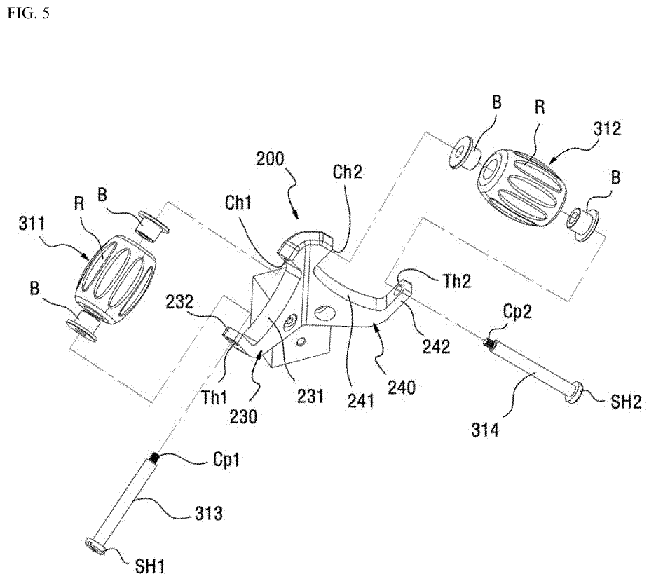

Meanwhile, with reference to FIGS. 5 to 7, the specific configurations and effects referring to the first pressurizing supporter 110 is provided at the end of the first massager 210 and the second pressurizing supporter 120 provided at the end of the second massager 220 will be explained later.

The first massager 210 and the second massager 220 of the skin care device according to an embodiment of the present invention have substantially the same configuration, and a pair of massage rollers 310 and 320 provided in each of them is also substantially identical to each other.

Accordingly, in the following description with reference to FIGS. 5 to 7, the first massager 210 and the second massager 220 are collectively referred to as massagers, and a pair of massage rollers 310 and 320 provided on each massager will be described as representative of the first massage roller 311 and the second massage roller 312.

Meanwhile, referring to FIG. 5 will be described with respect to the configuration of the massager of the skin care device according to an embodiment of the present invention.

As shown in FIG. 5, the massager of the skin care device according to an embodiment of the present invention may be configured to include a supporting body 200, a first massage roller 311 and a first roller shaft 313, and a second massage roller 312 and a second roller shaft 314.

The supporting body 200 is an element configured to support a state in which the first massage roller 311 and the second massage roller 312 are arranged to simultaneously contact the skin, and corresponding to a body of the massager.

The supporting body 200 may include a first roller supporter 230 supporting the first massage roller 311 to be rotatable and a second roller supporter 240 supporting the second massage roller 312 to be rotatable as shown in FIG. 5.

As shown in FIG. 5, a first roller supporter 230 is provided with a first roller installation part 231 on which a first massage roller 311 is installed, and a second roller supporter 240 is provided with a second roller installation part 241 on which a second massage roller 312 is installed.

A coupling groove Ch1 is formed at one end of the first roller installation part 231 of the first roller supporter 230 and a through hole Th1 is formed at the first shaft supporter 232 of the other end of the first roller installation part 231 of the first roller supporter 230.

In the state where the first massage roller 311 is seated on the first roller installation part 231, the first roller shaft 313 is installed by passing through the through hole Th1 of the first shaft supporter 232 and the hollow center of the first massage roller 311 so that a coupling part Cp1 of end of the first roller shaft 313 is coupled to the coupling groove Ch1.

Wherein, a shaft head SH1 is provided on the opposite side where the coupling part Cp1 of the first roller shaft 313 is formed, so that the coupling part Cp1 of the first roller shaft 313 is coupled to the coupling groove Ch1 and engaged to the first shaft supporter 232, and the first roller shaft 313 may be securely fixed.

And, on both sides of the hollow center of the first massage roller 311, as shown in FIG. 5, bushings B are provided, respectively, so that the first massage roller 311 rotates smoothly around the first roller shaft 313.

In addition, a coupling groove Ch2 is formed at one end of the second roller installation part 241 of the second roller supporter 240 and a through hole Th2 is formed at the second shaft supporter 242 of the other end of the second roller installation part 241 of the second roller supporter 240.

In the state where the second massage roller 312 is seated on the second roller installation part 241, the second roller shaft 314 is installed by passing through the through hole Th2 of the second shaft supporter 242 and the hollow center of the second massage roller 312 so that a coupling part Cp2 of end of the second roller shaft 314 is coupled to the coupling groove Ch2.

Wherein, a shaft head SH2 is provided on the opposite side where the coupling part Cp2 of the second roller shaft 314 is formed, so that the coupling part Cp2 of the second roller shaft 314 is coupled to the coupling groove Ch2 and engaged to the second shaft supporter 242, and the second roller shaft 314 may be securely fixed.

And, on both sides of the hollow center of the second massage roller 312, as shown in FIG. 5, bushings B are provided, respectively, so that the second massage roller 312 rotates smoothly around the second roller shaft 314.

The first massage roller 311 and the second massage roller 312 may be implemented in substantially the same shape, and may be configured such that a plurality of massage grooves R are formed at a predetermined intervals.

In figures such as FIG. 5, the first massage roller 311 and the second massage roller 312 are shown as having a shape of a rum barrel or a jar, but the present invention is not limited thereto. Any form that can exert a skin massage effect can be implemented as any type of roller.

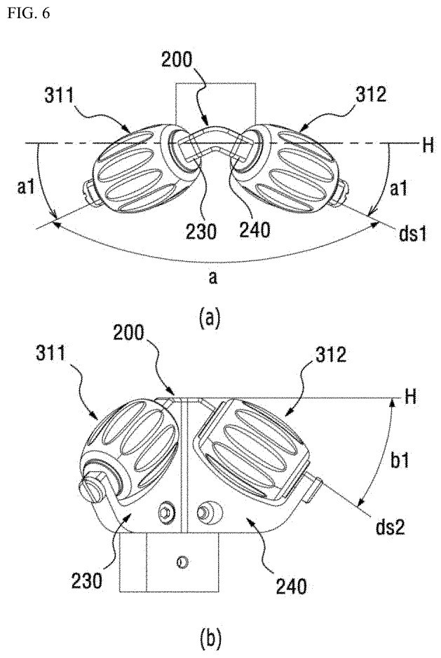

Meanwhile, as shown in FIG. 6(a), the first roller supporter 230 and the second roller supporter 240 of the massager of the skin care device according to an embodiment of the present invention, are configured to be inclined respectively at an angle less than 180 degrees in the skin contacting direction when viewed from above.

That is, the center line ds1 of the first roller shaft of the first massage roller 311 is inclined by al angle inward relative to the horizontal line H, and the center line ds2 of the second roller shaft of the second massage roller 312 is inclined by al angle inward relative to the horizontal line H so that the first massage roller 311 and the second massage roller 312 can be configured to form an angle ‘a’ less than 180 degrees in the direction of skin contact. That is, the first massage roller 311 and the second massage roller 312 are closed at a predetermined angle in the skin contacting direction.

Therefore, by the above configuration, the first massage roller 311 of the first roller supporter 230 and the second massage roller 312 of the second roller supporter 240, on contacting the skin, can wrap the contacted skin by the pressure between the first pressurizing supporter and the second pressurizing supporter.

And, as shown in FIG. 6(b), in the massager of the skin care device according to an embodiment of the present invention, when viewed from the front, the first massage roller 311 and the second massage roller 312 may be configured at an angle in which the outside is inclined downward with respect to the horizontal line H, respectively.

That is, the center line ds2 of the first roller shaft is inclined downward at an angle b1 with respect to the horizontal direction H, and the center line ds2 of the second roller shaft is inclined downward at the angle b1 with respect to the horizontal direction H, and the center lines of the two roller shafts can be configured to form a “ [symbol] ” shape.

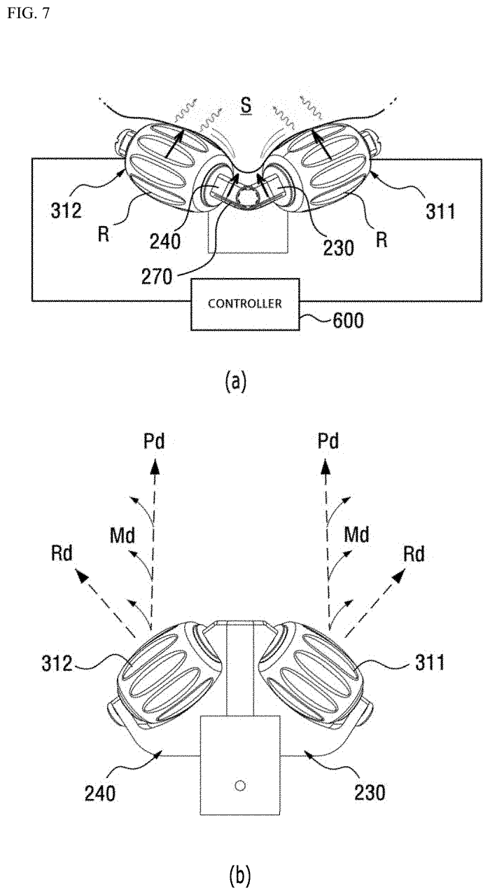

The operation according to the configuration of the massage rollers 311 and 312 as described above will be described with reference to FIG. 7.

According to the first massage roller 311 and the second massage roller 312 are configured to form an angle less than 180 degrees in the skin contacting direction as described above, as shown in (a) of FIG. 7, in a state where the first massage roller 311 of the first roller supporter 230 and the second massage roller 312 of the second roller supporter 240 wraps the skin in close contact by the pressing force of the first pressurizing supporter and the second pressurizing supporter during skin contact, by moving the handle, the first massage roller 311 and the second massage roller 312 can be massaged along the contacted skin, thereby further improving the massage effect on the skin.

As described above, while the first massage roller 311 and the second massage roller 312 wrap the skin in close contact so as to improve the massage effect by the massage groove R, the controller 600 controls to apply radio-frequency electrical stimulation to the skin through the first massage roller 311 and second massage roller 312, thereby more effectively decomposing fat on the skin and more effectively improving the elasticity of the skin.

Wherein, in order for the first massage roller 311 and the second massage roller 312 to contact to the skin more closely, as shown in FIG. 7(a), it is also possible to be configured to have an elastic pressing member 270 that provides elastic force with the first roller supporter 230 and the second roller supporter 240 in a direction inclined at an angle smaller than 180 degrees in the skin contacting direction.

The elastic pressing member 270 as described above may be embodied as a coil spring, etc. When the elastic pressing member 270 is provided, the first roller supporter 230 and the second roller supporter 240 are preferably configured to be able to rotate to some extent in the direction narrowed by the elastic pressing force of the elastic pressing members 270.

For example, the first roller supporter 230 and the second roller supporter 240 may be configured to rotate with each other about a center hinge axis, and the elastic pressing member 270 can be provided on the center hinge axis, the first roller supporter 230 and the second roller supporter 240 can rotate, respectively, in the direction narrowed by the elastic pressing force of the elastic pressing members 270.

When each of the massagers contact to the skin on both sides, in a state where the supporting body of each of the massagers wraps the skin in close contact by the pressing force of the first pressurizing supporter and the second pressurizing supporter during skin contact and the elastic force of the elastic pressing member 270, skin massages can be performed and thereby further improving the massage effect on the skin.

Meanwhile, as described in FIG. 6(b), by configuration that the first massage roller 311 and the second massage roller 312 are respectively inclined downward by making the center lines of the two roller shafts have a “ [symbol] ” shape with respect to the horizontal direction, as shown in FIG. 7(b), the rolling and going direction Rd1 of the first massage roller 311 rotated by the first roller shaft and the moving direction Pd of the supporting body according to the movement of the handle can occur a deviation of the angles. Similarly, the rolling and going direction Rd2 of the second massage roller 312 rotated by the second roller shaft and the moving direction Pd of the supporting body according to the movement of the handle can occur a deviation of the angles.

As the rolling and going direction Rd1 of the first massage roller 311 and the moving direction Pd of the supporting body, and the rolling and going direction Rd2 of the second massage roller 312 and the moving direction Pd of the supporting body occur the deviations, according to the supporting body moves in the direction of movement Pd, each of the massage rollers 311 and 312 does not simply rotate along the moving direction Pd, but obtain a massage effect of pressing the skin toward the side with respect to the movement direction Pd in the direction indicated by reference number Md in FIG. 7(b).

That is, each of the massage rollers 311 and 312 can massage the skin similar to pressing and spreading the skin with a thumb, thereby further improving the massage effect.

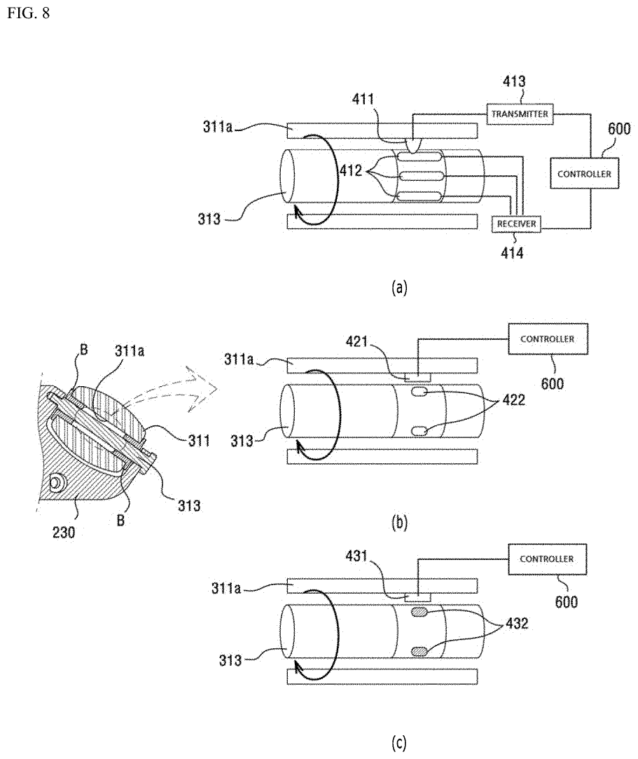

Meanwhile, various specific examples of the rotating detector described in FIG. 3 will be described with reference to FIG. 8.

The left side of FIG. 8 shows a cross section of one of the roller supporters 230 of both roller supporters of the supporting body of the skin care device according to an embodiment of the present invention, as shown, the configuration is shown that the bushings B are installed at both ends of the roller shaft 313 and the roller shaft 313 penetrates through the hollow center of the massage roller (311).

Wherein, a space between the roller shaft 313 and the massage roller 311 is formed between one bushing B and the other bushing B, and a rotating detector as described above can be implemented through the space. Here, the surface facing the roller shaft 313 of the massage roller 311 will be referred to as a roller inner surface 311a.

FIG. 8(a) to (c) are enlarged showing the roller inner surface 311a and the roller shaft 313, and examples of various rotating detectors are shown, respectively. The illustrated example will be described.

As shown in FIG. 8(a), a contact terminal 411 is provided at a position facing the roller shaft 313 of the roller inner surface 311a, and a plurality of contacts 412 are provided along circumference of the roller shaft 313 with predetermined intervals. And when the massage roller 311 rotates with respect to the roller shaft 313, in a state in which the contact terminal 411 is configured to sequentially contact the plurality of contacts 412, a rotating detector is configured to include a transmitter 413 for transmitting a preset signal to the contact terminal 411, and a receiver 414 connected to each of the plurality of contacts 412 to receive a signal from the contact 412 that the contact terminal 411 contacts.

That is, when the massage roller 311 rotates in the state as shown in FIG. 8 (a), the contact terminal 411 rotates in contact with the outer surface of the roller shaft 313 and then contacts the contact 412. When the predetermined signal is received by the receiver 414, when the contact between the contact and the contact is not received by the receiver 414. Therefore, according to the rotation of the massage roller 311, the receiver 414 repeatedly receives a predetermined signal at time intervals. Wherein the transmitter 413 continuously transmits a predetermined signal.

The controller 600 analyzes the signal received by the receiver 414 to provide radio-frequency electric stimulation when the massage roller 311 rotates, or calculates the rotational speed of the massage roller 311 and controls to provide radio-frequency electrical stimulation according to the calculated rotational speed of the massage roller 311.

The controller 600 may determine that the skin care device is being used when the receiver 414 receives a signal of a predetermined pattern, and may apply a radio-frequency current.

Or, through the pattern of the signal received by the receiver 414, the period of the signal and the rotation speed using the period can be calculated. When the calculated rotation speed is included in a range of a predetermined speed value, it is determined that the user is using the skin care device and a radio-frequency current can be applied.

Meanwhile, as shown in FIG. 8(b), the rotating detector used in the present invention may be implemented as a magnetic sensor 421 provided at a position opposite to the roller shaft 313 of the roller inner surface 311a.

Wherein, a plurality of magnetic bodies 422 are provided at predetermined intervals along the circumference of the roller shaft 313, when the massage roller 311 rotates with respect to the roller shaft 313, so that the massage sensor 311 rotates with respect to the roller shaft 313, so that the magnetic sensor 421 may sequentially detect magnetic field from each of the plurality of magnetic bodies 422. The controller 600 may receive the detected signal from the magnetic sensor 421.

The controller 600 may analyze a signal sensed by the magnetic sensor 421 to provide radio-frequency electric stimulation when the massage roller 311 rotates, or to calculate the rotational speed of the massage roller 311 and provide radio-frequency electric stimulation according to the calculated rotational speed.

That is, when the massage roller 311 rotates in the state as shown in FIG. 8 (b), the magnetic sensor 421 provided in the roller inner surface 311a rotates along circumference of the roller shaft 313 and then sensing signal of the magnetic sensor 421 changes rapidly according to receiving magnetic field as passing the magnetic body 422. Wherein the magnetic sensor 421 generates a signal that repeats in a predetermined pattern while sequentially passing through the plurality of magnetic bodies 422, and the controller 600 analyzes it to calculate the rotational speed of the massage roller 311.

Accordingly, the controller 600 may determine that the skin care device is being used through analysis of the signal output by the magnetic sensor 421 and apply a radio-frequency current, or when the calculated rotational speed is a predetermined range of speed values, the controller 600 may determine that the skin care device is being used and apply a radio-frequency current.

Meanwhile, as shown in FIG. 8(c), The rotating detector may be configured to include a photosensor 431 provided at a position opposite to the roller shaft 313 of the roller inner surface 311a and a plurality of reflectors 432 provided at predetermined intervals along the circumference of the roller shaft 313.

The photosensor 431 is a reflective optical sensor, and is a sensor that irradiates light in a predetermined direction and receives the light reflected therefrom.

When the massage roller 311 rotates with respect to the roller shaft 313, a photosensor 431 irradiates light, and the photosensor 431 senses reflected light as it passes through the reflector 432, and sensing of the reflected light occurs at intervals as the photosensor 431 sequentially passes through the plurality of reflectors 432 while the massage roller 311 rotates.

The controller 600 may analyze a signal sensed by the photosensor 431 to provide radio-frequency electrical stimulation when the massage roller 311 rotates, or to calculate the rotational speed of the massage roller 311 and provide radio-frequency electric stimulation according to the calculated rotational speed.

That is, when the massage roller 311 rotates in the state as shown in FIG. 8 (c), the photosensor 431 provided in the roller inner surface 311a rotates along circumference of the roller shaft 313 and then detects a reflected light as passing through the reflector 432, wherein the photosensor 431 generates a signal that repeats in a predetermined pattern while sequentially passing through the plurality of reflectors 432, and the controller 600 analyzes it to calculate the rotational speed of the massage roller 311.

Accordingly, the controller 600 may determine that the skin care device is being used through analysis of the signal output by the photosensor 431 and apply a radio-frequency current, or when the calculated rotational speed is a predetermined range of speed values, the controller 600 may determine that the skin care device is being used and apply a radio-frequency current.

Meanwhile, in FIG. 8(c), a case was described in which a rotating detector may be configured with a combination of ‘photosensor-reflector’, and on the same principle, a rotating detector may be configured using a combination of ‘light receiving sensor-light emitter’.

As the light receiving sensor rotates along the circumference of the roller shaft 313 and can detect light emitted by the light emitter, wherein the light receiving sensor generates a signal that repeats in a predetermined pattern while sequentially passing through the plurality of light emitters, and the controller 600 may control to generate a radio-frequency current based on the generated signal from the light receiving sensor.

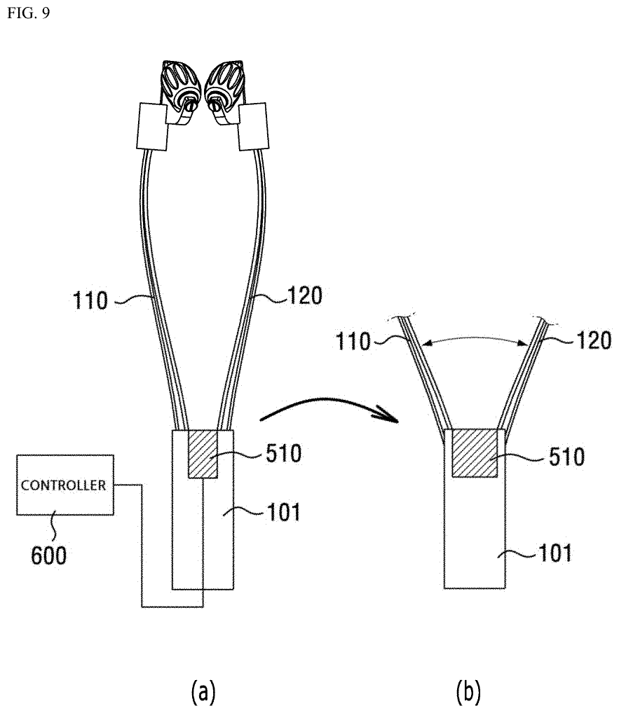

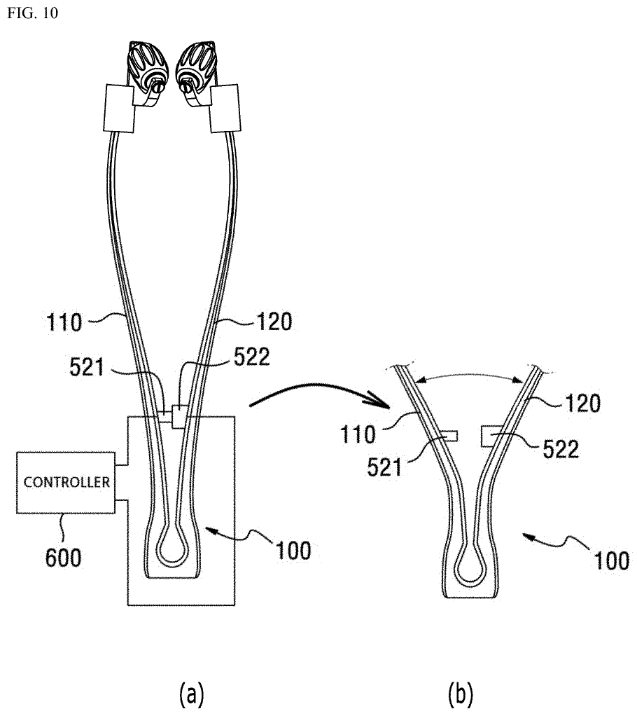

Meanwhile, with reference to FIGS. 9 and 10 will be described with reference to various specific examples of the pressure sensor described above with reference to FIG. 4.

FIG. 9 shows an example configured to include a strain gauge 510 provided in the handle body 101 of the handle portion as a pressure sensor used in the skin care device according to an embodiment of the present invention.

The strain gauge 510 indicates pressure between the first pressurizing supporter 110 and the second pressurizing supporter 120. When the gap between the first pressurizing supporter 110 and the second pressurizing supporter 120 is broaden as shown from FIG. 9(a) to FIG. 9(b), the output pressure from the strain gauge 510 is changed.

And when the controller 600 detects whether the first pressurizing supporter 110 and the second pressurizing supporter 120 are in a broaden state according to the pressure detected by the strain gauge 510, the controller 600 can provide a radio-frequency electrical stimulation if the broaden state continues for a predetermined time.

Wherein the controller 600 may not provide a radio-frequency electrical stimulation by determining that the user is not in a state of using a skin care device when the pressure sensed by the strain gauge 510 does not reach a predetermined value.

Meanwhile, FIG. 10 shows that a contact point 521 and a contact switch 522 provided in the first pressurizing supporter 110 and the second pressurizing supporter 120 as pressure sensor used in the skin care device according to an embodiment of the present invention.

As shown in FIG. 10(a), in a normal state the contact point 521 is in contact with the contact switch 522. When the gap between the first pressurizing supporter 110 and the second pressurizing supporter 120 is broaden, as shown in FIG. 10(b), the contact point 521 and the contact switch 522 may be configured to be separated from each other.

When the contact point 521 and the contact switch 522 are in contact with each other, the controller 600 may receive a signal transmitted from the contact point 521 through the contact switch 522, however when the contact point 521 and the contact switch 522 are disconnected to each other, the controller 600 is unable to receive a signal from the contact switch 522, so that it is possible to detect whether the gap between the first pressurizing supporter 110 and the second pressurizing supporter 120 is broaden.

The controller 600 may detect whether the first pressurizing supporter 110 and the second pressurizing supporter 120 are in a broaden state by detecting that the contact switch is open or closed, and when the broaden state lasts for a predetermined time, the controller 600 can provide radio-frequency electrical stimulation.

Meanwhile, the skin care device according to an embodiment of the present invention may include a skin contact detector 530 as a means for improving safety, in addition to the rotating detector of FIGS. 3 and 8, and the pressure sensor of FIGS. 4, 9 and 10.

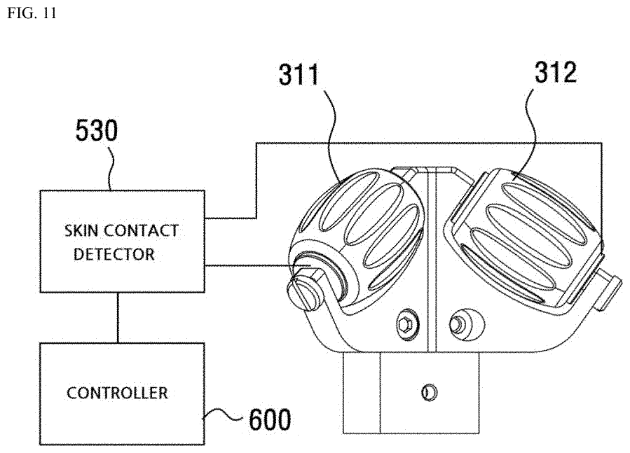

That is, as shown in FIG. 11, a preset signal is transmitted to the first massage roller 311 and the second massage roller 312 provided by each massager, and the skin contact detector 530 may detect whether the massage rollers 311 and 312 contact the skin by comparing the signals received from the massage rollers 311 and 312 with the transmitted signal.

The above stated skin contact detector 530 uses a principle applied to the signal applied to each massage roller 311, 312 is modified by the impedance of the skin when each massage roller 311, 312 is in contact with the skin.

The controller 600 may provide radio-frequency electrical stimulation when the state where the pair of massage rollers 311 and 312 contact the skin continues for a predetermined time according to the detection result of the skin contact detector 530.

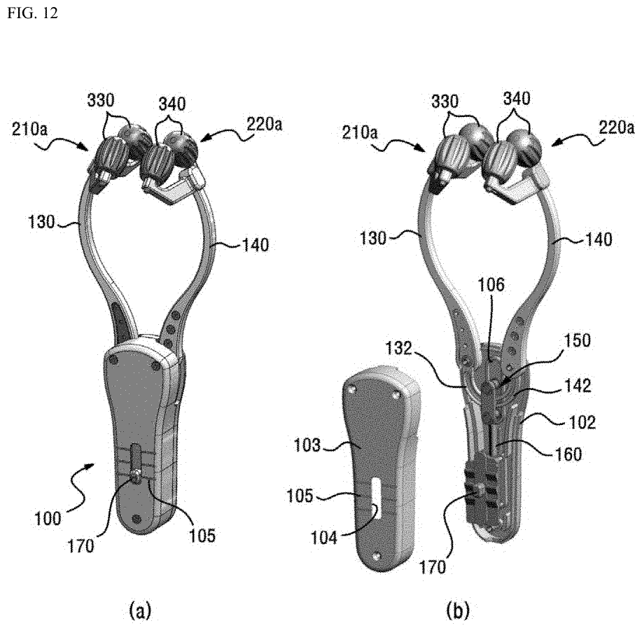

Meanwhile, the skin care device according to another embodiment of the present invention will be described in detail with reference to FIGS. 12 to 19.

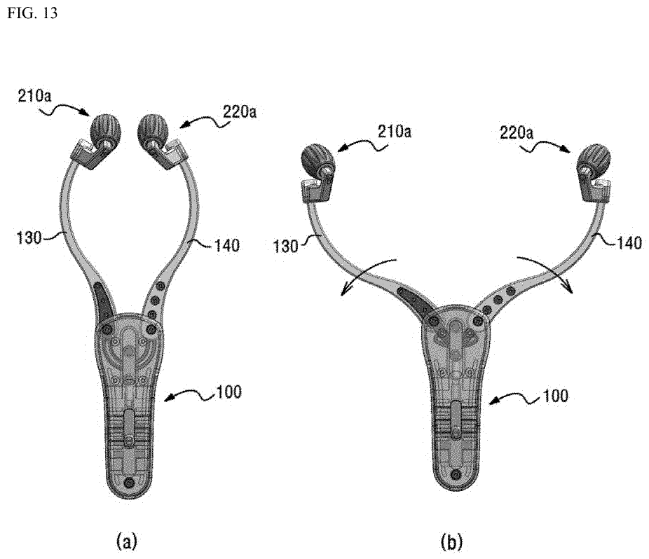

First, a configuration of the skin care device according to another embodiment of the present invention will be described with reference to FIGS. 12 and 13.

FIG. 12(a) shows a basic configuration of the skin care device according to another embodiment of the present invention, and FIG. 12(b) is a view showing an internal configuration of the skin care device. FIGS. 13(a) and 13(b) show an operation state of the skin care device shown in FIG. 12.

As shown in FIGS. 12 and 13, the skin care device according to another embodiment of the present invention includes a handle 100 having a first pressurizing supporter 130 and a second pressurizing supporter 140, a first massager 210a provided at an end of the first pressurizing supporter 110 and a second massager 220a provided at end of the second pressurizing supporter 120, and a controller.

The skin care device according to this embodiment, unlike the embodiment shown in FIG. 1, as shown in FIGS. 12 (a) and (b), the handle 100 is configured to a casing including a handle case 102 and a handle cover 103, and the first pressurizing supporter 130 and the second pressurizing supporter 140 are respectively coupled to be rotatable in the handle case 102 so as to be rotatable.

FIG. 12(b) shows a state in which the handle cover 103 of the skin care device as shown in FIG. 12(a) is removed, as shown in FIG. 12(b). the first pressurizing supporter 130 and the second pressurizing supporter 140 are configured to be rotatable on one side and the other side of the handle case 102, respectively.

As shown in FIG. 12(b), the first pressurizing supporter 130 includes a first rotating guide 132 fixed to one side thereof, and the second pressurizing supporter 140 includes a second rotating guide 142 fixed to one side thereof.

The first rotating guide 132 and the second rotating guide 142 is supported by a gripper 150, wherein the gripper 150 is configured to guide that the first rotating guide 132 and second rotating guide 142 are respectively rotating as the first pressurizing supporter 130 and second pressurizing supporter 140 rotate respectively.

As shown in FIG. 12(b), the first rotating guide 132 and the second rotating guide 142, and the gripper 150 are provided at the upper portion of the handle case 102, and a pressing force adjuster 170 is provided at the lower portion, wherein an elastic member 160 is provided between the gripper 150 and the pressing force adjuster 170, and the elastic member 160 provides an elasticity between the first pressurizing supporter 130 and the second pressurizing supporter 140 when the first pressurizing supporter 130 and the second pressurizing supporter 140 are respectively, rotated and broaden, wherein the first pressurizing supporter 130 and the second pressurizing supporter 140 allow the pressing force to act in a direction to approach each other by the elastic force of the elastic member 160.

The protrusion of the pressing force adjuster 170 is exposed to the outside through the long groove 104 of the handle cover 103, and the user can adjust the pressing force while manipulating the protrusion of the pressing force adjuster 170, wherein according to the adjustment step indicator 105 formed on the front of the handle cover 103, the pressing force can be adjusted stepwise while manipulating the protrusions in each step. More details on this will be described later.

One end of the elastic member 160 is coupled to the gripper 150 and the other end is fixed by being coupled to the pressing force adjuster 170, the elastic member 160 may be implemented as one or more springs.

According to the above described configurations, when, from the state as shown in FIG. 13(a), the first pressurizing supporter 130 and the second pressurizing supporter 140 are positioned on the skin, such as the user's face and broaden between each other, it becomes the state as shown FIG. 13(b).

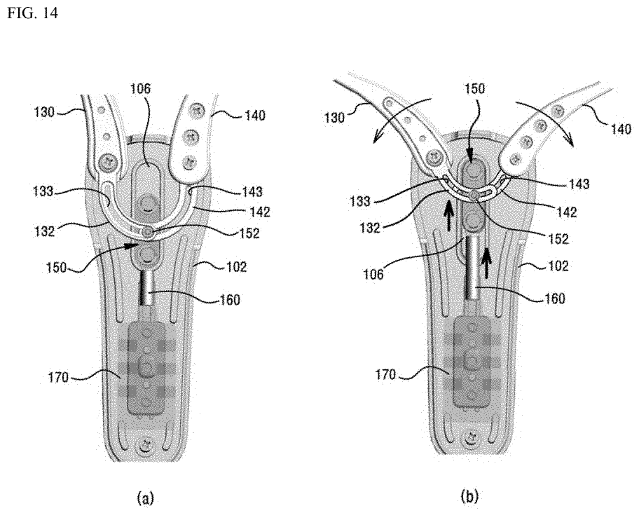

More details about the operation of the rotating guides 132 and 142, the gripper 150, and the elastic member 160 of the pressurizing supporters 130 and 140 as described above will be described with reference to FIGS. 14(a) and (b).

FIG. 14(a) is an enlarged view of a main part when the skin care device is in a normal state corresponding to FIG. 13(a), and FIG. 14(b) is an enlarged view of a main part when the pressurizing supporters are broaden from each other corresponding to FIG. 13(b).

As shown in FIGS. 14(a) and (b), the first pressurizing supporter 130 and the second pressurizing supporter 140 coupled to be rotatable at positions symmetrical to each other on the upper part of the handle case 102 include a first rotating guide 132 and a second rotating guide 142, respectively, and the first rotating guide 132 forms a curved guide groove 133 and the second rotating guide 142 forms a curved guide groove 143.

And, in the state that the curved guide grooves 133 and 143 of the first rotating guide 132 and the second rotating guide 142 are overlapped with each other, the curved guide grooves 133 and 143 are fixed to the gripper 150 by a grip part 152 of the gripper 150 passing through the curved guide grooves 133 and 143, wherein the gripper 150 may be configured to slide up and down in the slide groove 106 formed in the handle case 102 as shown in FIGS. 14(a) and (b).

That is, as shown in FIGS. 14(a) and (b), as the first pressurizing supporter 130 and the second pressurizing supporter 140 rotate in the direction of the arrow, the first rotating guide 132 and the second rotating guide 142 are rotated, respectively, wherein the grip part 152 can guide rotation of the first rotating guide 132 along the curved guide groove 133 of the first rotating guide 132 and guide rotation of the second rotating guide 142 along the curved guide groove 143 of the second rotating guide 142, accordingly, the gripper 150 moves upward along the slide groove 106.

Wherein, since one end of the elastic member 160 is coupled to the gripper 150, the gripper 150 moves while pulling the elastic member 160 when moving upward, so that an elastic restoring force of the stretched elastic member 160 pulls the gripper 150 downward, whereby the first pressurizing supporter 130 and the second pressurizing supporter 140 have pressure to pull each other.

As the user places the first massager 210a of the first pressurizing supporter 130 and the second massager 220a of the second pressurizing supporter 140 on the skin area, such as the face and the first pressurizing supporter 130 and second pressurizing supporter 140 rotate, the gripper 150 moves upward by the first rotating guide 132 and second rotating guide 142, wherein the first pressurizing supporter 130 and the second pressurizing supporter 140 pull each other by the gripper 150 pulling the elastic member 160 so that the elastic member 160 pulls the gripper 150 with elastic restoring force.

If the massager 210a and 220a leave the user's face after the massage is finished, the gripper 150 moves downward by the elastic restoring force of the elastic member 160, accordingly, the first pressurizing supporter 130 and the second pressurizing supporter 140 are returned to the original state while the first rotating guide 132 and the second rotating guide 142 rotate around the grip part 152.

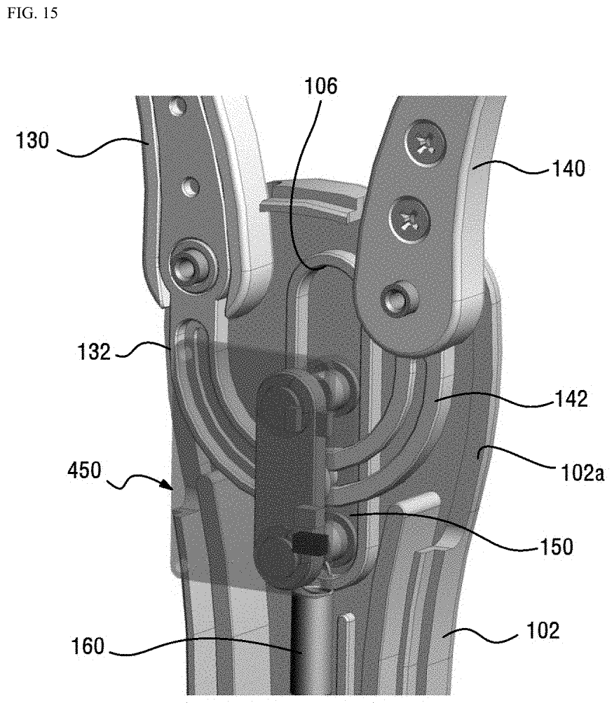

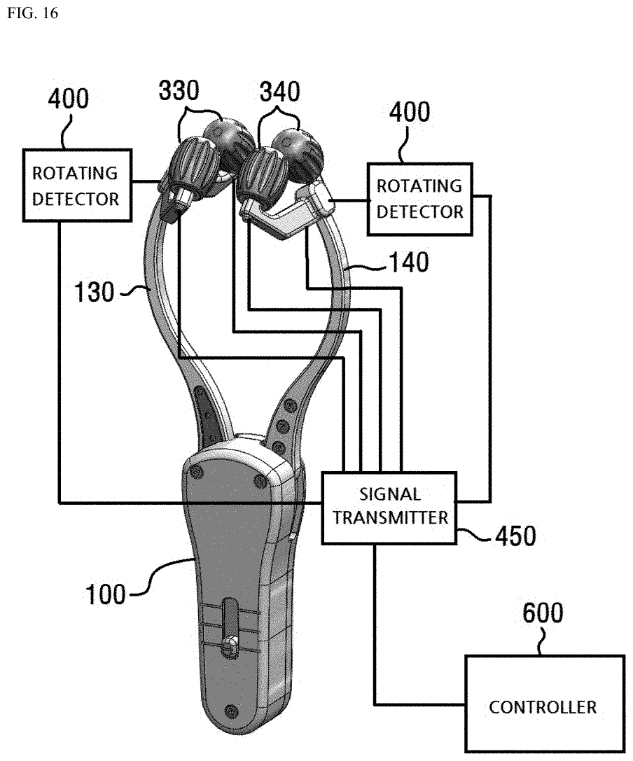

Meanwhile, with reference to FIGS. 15 and 16, the configuration of the signal transmission and control of the skin care device according to another embodiment of the present invention will be described.

FIG. 15 is an enlarged view of a configuration inside the handle case 102 shown in FIG. 12(b), and is a configuration omitted from FIG. 12(b), showing the signal transmitter 450 in translucent.

In FIG. 15, various configurations described above are more enlarged, and an unexplained number 102a is a rotating groove formed on the upper side of the handle case 102 so that the first pressurizing supporter 130 and second pressurizing supporter 140 can rotate.

Meanwhile, the skin care device according to another embodiment of the present invention, similar to the skin care device shown in FIGS. 3 and 4, a pair of massage rollers 330 and 340 provided by each of the first massager 210a and the second massager 220a respectively provides radio-frequency electric stimulation when in contact with the skin, or when the pair of massage rollers 330 and 340 are rotating in contact with the skin according to the movement of the handle 100, the controller provides radio-frequency electrical stimulation through each massage roller 330, 340.

Thus, when the pair of massage rollers 330 and 340 do not come into contact with the skin or do not rotate, the controller may control to block the provision of the radio-frequency electrical stimulation, thereby preventing the risk of electric shock and improving safety.

As shown in FIG. 16, the skin care device according to another embodiment of the present invention may also include a rotating detector 400 which detects whether each of the massage rollers 330 and 340 rotates or not, or detects a rotating speed of each of the massage rollers 330 and 340, similar to the skin care device shown in FIGS. 3 and 4.

As shown in FIG. 16, the controller 600 receives a detection signal from each rotating detector 400 and also controls signals such as applying or blocking radio-frequency electricity to each of the massage rollers 330 and 340, but if various signal lines for transmitting and receiving signals are directly connected to the controller 600, it makes the device more complicated, so it is possible to simplify the transmission system of the control signal using a signal transmitter 450.

That is, as shown in FIG. 16, the signal transmitter 450 may be configured to be electrically connected to the controller 600 in a wireless or wired manner.

When the signal transmitter 450 and the controller 600 are wirelessly connected, a wireless communication module capable of near field communication such as Bluetooth may be additionally mounted on the signal transmitter 450 and correspondingly the controller 600 can also be equipped with a wireless communication module.

The signal transmitter 450 receives various control signals including signals related to radio-frequency electrical stimulation transmitted from the controller 600 and transmits them to massage rollers 330 and 340 of the first and second massagers, respectively. The signal transmitter 450 transfers electric signals, ie, detection signals transmitted from the rotating detector 400, received from each massage roller 330 and 340 to the controller 600.

Inside the handle case 102, signal lines may be configured more complicatedly, but the controller 600 only needs to be connected to the signal transmitter 450 singly to simplify the control configurations.

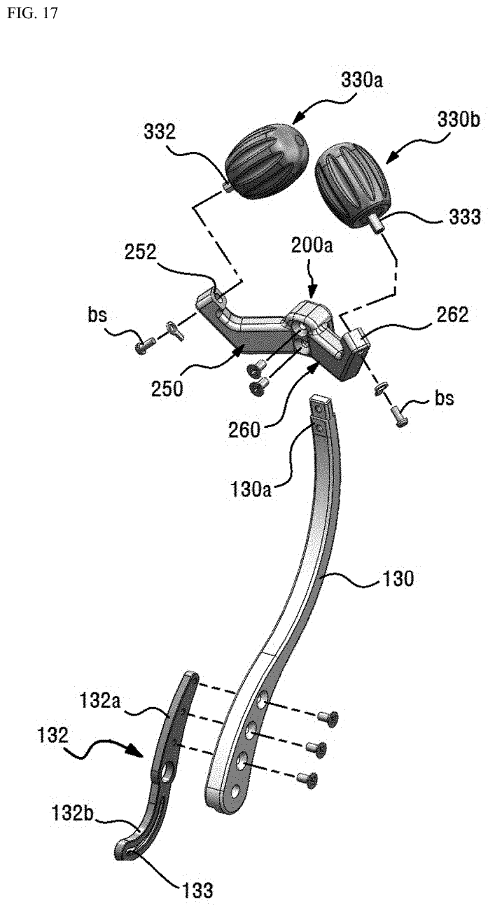

Meanwhile, referring to FIGS. 17 to 19, it will be described about a specific configuration and effects for the first massager 210a provided at the end of the first pressurizing supporter 130 and the second massager 220a provided at the ends of the second pressurizing supporter 140.

The first massager 210a and the second massager 220a of the skin care device according to another embodiment of the present invention have substantially the same configuration, and a pair of massage rollers 330 and 340 provided in each of them is also substantially identical to each other.

Accordingly, in the following description with reference to FIGS. 17 to 19, the first massager 210a and the second massager 220a are collectively referred to as massagers, and a pair of massage rollers 330 and 340 provided on each massager will be described as representative of the first massage roller 330a and the second massage roller 330b.

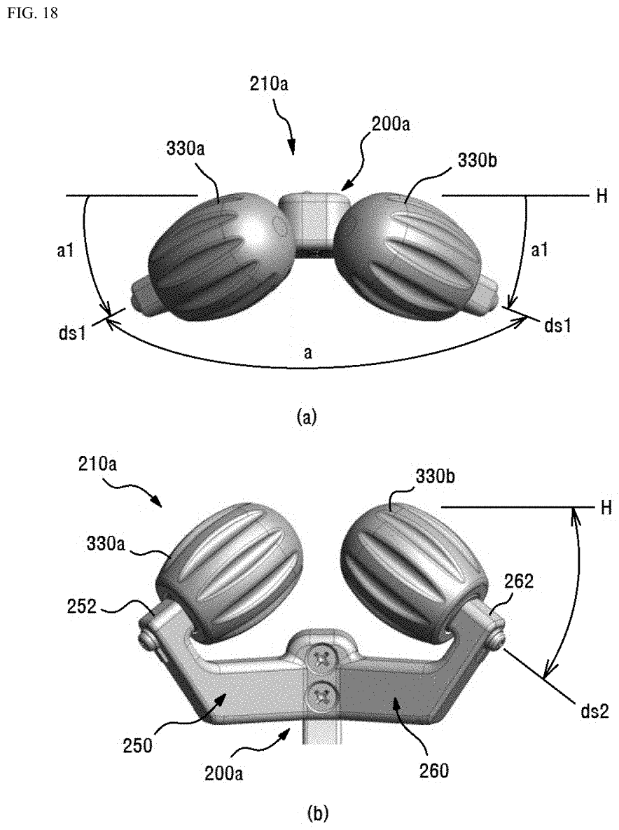

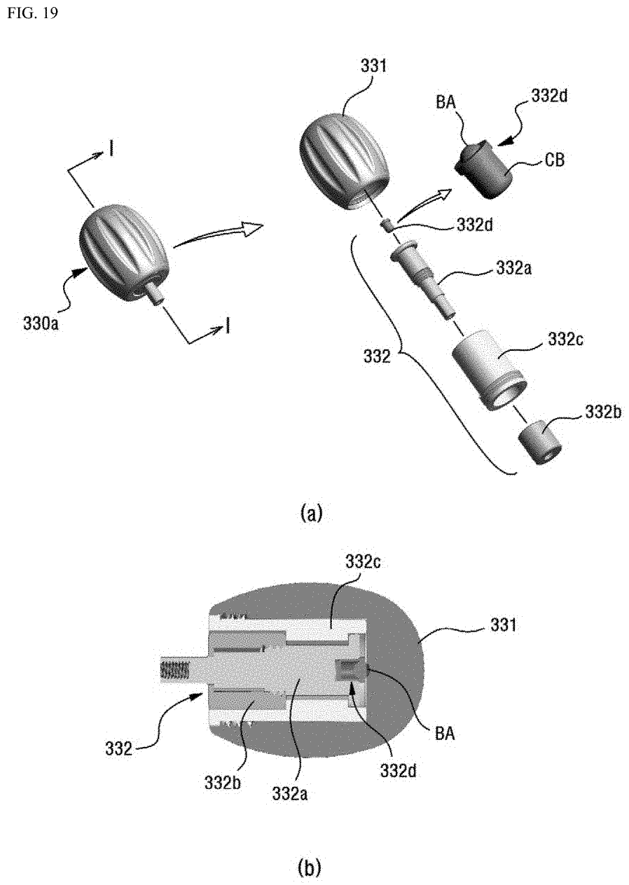

FIG. 17 is an exploded perspective view showing the configuration of a massager of a skin care device according to another embodiment of the present invention, FIG. 18 (a) is a plan view of the combined state of the massager shown in FIG. 17, FIG. 18(b) is a front view of the combined state of the massager shown in FIG. 17, FIG. 19 (a) is an exploded perspective view showing the configuration of one massage roller 330a shown in FIG. 17, and FIG. 19(b) is a cross-sectional view showing the I-I cross section of FIG. 19(a).

First, a configuration of the pressurizing supporter and massager of the skin care device according to another embodiment of the present invention will be described with reference to FIG. 17.

As shown in FIG. 17, the massager of the skin care device according to another embodiment of the present invention includes a supporting body 200a, a first massage roller 330a and a second massage roller 330b, wherein the supporting body 200a may be configured such that a support part coupling 130a provided at one end of the pressurizing supporter 130 is coupled and fixed.

And the other end of the pressurizing supporter 130 is configured such that the rotating guide 132 is fixed, wherein the rotating guide 132 has a guide coupling part 132a coupled to the pressurizing supporter 130 and a guide part 132b having a curved guide groove 133.

The supporting body 200a is an element configured to support a state in which the first massage roller 330a and the second massage roller 330b are arranged to simultaneously contact the skin, and is an element corresponding to a body of the massager.

Compared with the supporting body 200 of FIG. 5 described above, there is a difference in that the supporting body 200a in the present embodiment shown in FIG. 17 does not support on both sides of the massage roller 330a or 330b, but support on one side of the massage roller 330a or 330b

The supporting body 200a in the present embodiment shown in FIG. 17 also includes a first roller supporter 250 supporting the first massage roller 330a to be rotatable, and a second roller supporter 260 supporting the second massage roller 330b to be rotatable.

As shown in FIG. 17, a first fixing bearing 252 is provided on one side of the first roller supporter 250 so that the first supporting shaft 332 protruding to one side of the first massage roller 330a is fixed to the first fixing bearing (252) by a fixing member bs, and the first massage roller 330a is configured to be rotatable by the first supporting shaft 332.

Also, a second fixing bearing 262 is provided on one side of the second roller supporter 260 so that a second supporting shaft 333 protruding to one side of the second massage roller 330b is fixed to the second fixing bearing 262 by a fixing member bs, and the second massage roller 330b is configured to be rotatable by the second supporting shaft 333.

A detailed description of the configuration in which the massage rollers 330a and 330b can be rotated by the supporting shafts 332 and 333 will be described with reference to FIG. 19 below.

Meanwhile, FIGS. 18(a) and (b) correspond to FIGS. 6(a) and (b) described above, although there is a difference in the configuration in which the massage rollers are combined, features of the angles formed by the pair of massage rollers, etc. are substantially the same.

That is, as shown in FIG. 18(a) similar to FIG. 6(a), the massager 210a in the present embodiment has a first roller supporter 250 and a second roller supporter 260 which may be configured to incline at an angle less than 180 degrees in the contact direction, when viewed from above.

That is, the center line ds1 of the first supporting shaft of the first massage roller 330a is inclined by an angle al inward with respect to the horizontal line H, and the center line ds1 of the second supporting shaft of the second massage roller 330b is also inclined by the angle al inward with respect to the horizontal line H, so that the first massage roller 330a and the second massage roller 330b can be configured to form an angle less than 180 degrees in the direction of skin contact (both massage rollers can wrap the contacted skin).

In this embodiment as shown in FIG. 18 (b), the massager 210a may be configured to have an angle in which the first massage roller 330a and the second massage roller 330b are inclined downward from the horizontal line H when viewed from the front. That is, the center lines of the two supporting shafts can be configured to form a shape. The effect is substantially the same as that described with reference to FIG. 7 above.

And although not shown in the drawings, in the present embodiment, the supporting body 200a may be also include the elastic pressing member as shown in FIG. 7(a) for more closely contact the skin.

Meanwhile, as shown in FIG. 19(a), the massage roller 330a includes a supporting shaft 332 and a roller cap 331 that is fixed by covering the supporting shaft 332, so that the supporting shaft 332 is configured to be rotatable so that the roller cap 331 can be configured to rotate.

As shown in FIGS. 19(a) and (b), the supporting shaft 332 may be configured to include a shaft member 332a, a coupling support part 332b, a shroud 332c, and contact member 332d.

The shaft member 332a is the center of rotation of the massage roller 330a, and one end of the shaft member 332a is coupled to the first fixing bearing 252.

The shroud 332c is fitted to the shaft member 332a, but is inserted while maintaining a predetermined gap, and the shroud (332c) is configured to rotate around a shaft member fixed to the bearing 252 without being fastened with the shaft member 332a and separated from the shaft member 332a.

The shroud 332c is coupled to the roller cap 331 and rotates as the roller cap 331 rotates, but rotates based on a shaft member 332a.

In the state where the shroud 332c is fitted to the shaft member 332a, a coupling supporting part 332b is coupled to the end of the shaft member 332a, so that the shroud 332c does not depart from the shaft member 332a.

Meanwhile, the contact member 332d provided on the other end of the shaft member 332a, is in contact with the inside of the roller cap 331 to transmit radio-frequency electricity transmitted through the shaft member 332a to the roller cap 331.

Here, the contact member 332d is further enlarged on one side in FIG. 19(a), and referring to this, the contact member 332d is configured to include a contact base CB coupled to an end of the shaft member 332a, a spring provided inside the contact base CB, and a ball contact BA elastically supported by the spring and contacting the inside of the roller cap 331.

That is, as shown in FIG. 19(b), the contact base CB of the contact member 332d is coupled to the shaft member 332a and the ball contact BA of the ball shape elastically supported by a spring provided inside the contact base CB is in contact with the inside of the roller cap 331, wherein the ball contact BA is in closely contact with the elasticity by the spring inside the contact base (CB), even if a gap occurs while the roller cap 331 rotates, the ball contact BA can be stably contact to the inside of the roller cap 331.

Wherein, the shaft member 332a, the contact member 332d, and the roller cap 331 is preferably made of an electrically conductive material, the signal transmitter (450, see FIG. 16) and the shaft member 332a are electrically connected to each other, wherein

when a signal for radio-frequency electrical stimulation is transmitted from the controller to the signal transmitter 450, the signal transmitter 450 directly or indirectly transmits a signal for the radio-frequency electrical stimulation to the shaft member 332a, and the signal is transmitted to the roller cap 331 through the ball contact BA of the contact member 332d so as to transmit a radio-frequency electrical stimulation to the skin of the user in contact with the roller cap 331.

As shown in FIG. 19(b), a constant gap may be formed between the shaft member 332a and the shroud 332c or between the coupling supporter 332b and the shroud 332c, wherein the specific configuration of the rotating detector described above can be applied substantially the same.

As described above, configurations for sensing the rotation of the massage roller includes, i) a configuration using a contact terminal 411 and a plurality of contacts 412, ii) a configuration using a magnetic sensor 421 and a plurality of magnetic bodies 422, and iii) a configuration using a photosensor 431 and a plurality of reflectors 432.

Those configurations for sensing the rotation of the massage roller may be the skin care device according to another embodiment as shown in FIGS. 17 to 19 in the same manner.

Meanwhile, the configuration of the “pressure detector” as shown in FIG. 4 may also be applied to the embodiment shown in FIGS. 12 to 19.

For example, in FIG. 12(b), when the elastic member 160 is provided together with a pressure sensing device such as a load cell and the elastic member 160 is tensioned to generate an elastic restorable force (when the first pressurizing supporter and the second pressurizing supporter are broaden), it can cause the load cell to sense the pressure.

In addition, for example, between the gripper 150 and the slide groove 106, in a state that a contact terminal is provided at the gripper 150 and a contact point is provided in the upper portion of the slide groove 106, the first pressurizing supporter 130 and the second pressurizing supporter 140, as the first pressurizing supporter 130 and second pressurizing supporter 140 rotate, the gripper 150 moves upward by the first rotating guide 132 and the second rotating guide 142, respectively, and the first pressurizing by the contact terminal touching the contact point. Accordingly it is possible to detect that a pressing force is applied between the supporter 130 and the second pressurizing supporter 140.

Meanwhile, the configuration of the “skin contact detector 530” as illustrated in FIG. 11 may also be applied to the embodiment shown in FIGS. 12 to 19.

What is claimed is:

1. A skin care device comprising:
a handle provided with a first pressurizing supporter and a second pressurizing supporter, and a pressure force acting in a direction to approach each other according to a gap between the first pressurizing supporter and the second pressurizing supporter;
a first massager provided at an end of the first pressurizing supporter and having a pair of massage rollers that massage the skin as the handle is moved while in contact with the skin;
a second massager provided at an end of the second pressurizing supporter and having a pair of massage rollers that massage the skin as the handle is moved while in contact with the skin; and
a controller configured to control providing a radio-frequency electrical stimulation to the skin contacted through the pair of massage rollers provided by each of the first massager and the second massager.

2. The device according to claim 1, wherein each of the first massager and the second massager comprises a supporting body supporting a state the pair of massage rollers to simultaneously contact the skin, wherein
the supporting body is configured to comprise a first roller supporter supporting the first massage roller to be rotatable, and a second roller supporter supporting the second massage roller to be rotatable.

3. The device according to claim 1, wherein the handle includes a handle case and a handle cover covering the handle case,
the first pressurizing supporter and the second pressurizing supporter are combined to be rotatable on one side and the other side of the handle case, respectively, and
the device further comprising an elastic member applying an elastic force when the first pressurizing supporter and the second pressurizing supporter are rotated to be broaden each other and applying a pressing force in a direction to approach each other by the elastic force.

4. The device according to claim 3, wherein the first pressurizing supporter includes a first rotating guide fixed to one side, and the second pressurizing supporter includes a second rotating guide fixed to one side, and
the device further comprising a gripper that supports the first rotating guide and the second rotating guide, and guides the first rotating guide and the second rotating guide to rotate while the first pressurizing supporter and the second pressurizing supporter rotate, respectively.

5. The device according to claim 4, wherein the gripper is configured to move in the vertical direction while the first rotating guide and the second rotating guide are rotated as the first pressurizing supporter and the second pressurizing supporter rotate, respectively, and
the elastic member, one end is fixed and the other end is coupled to the gripper, so that the first pressurizing supporter and the second pressurizing supporter are rotated to give elasticity as the elastic force is generated according to the movement of the gripper in the vertical direction.

6. The device according to claim 2, wherein the first roller supporter is provided to fix both ends of the first roller shaft passing through the first massage roller, and the first massage roller is configured to be rotatable around the first roller shaft,
the second roller supporter is provided to fix both ends of the second roller shaft passing through the second massage roller, and the second massage roller is configured to be rotatable around the second roller shaft,
the first roller shaft is provided at an angle inclined downward with respect to the horizontal direction, and the direction in which the supporting body moves according to the rolling and going direction of the first massage roller rotated by the first roller shaft and the movement of the handle cause an angle deviation, and
the second roller shaft is provided at an angle inclined downward with respect to the horizontal direction to achieve left-right symmetry with the first roller shaft according to the rolling and going direction of the second massage roller rotated by the second roller shaft and the movement of the handle cause an angle deviation.

7. The device according to claim 2, wherein the first supporting shaft protruding to one side of the first massage roller is fixed to a first fixing bearing provided on one side of the first roller supporter, and the first massage roller is configured to be rotatable by the first supporting shaft,
the second supporting shaft protruding to one side of the second massage roller is fixed to a second fixing bearing provided on one side of the second roller supporter, and the second massage roller is configured to be rotatable by the second supporting shaft,
the first supporting shaft is fixed to the first fixing bearing at an angle inclined downward with respect to the horizontal direction, and the supporting body is moved according to the rolling and going direction of the first massage roller rotated by the first supporting shaft and the movement of the handle cause an angle deviation, and
the second supporting shaft is provided at an angle inclined downward with respect to the horizontal direction to achieve left-right symmetry with the first supporting shaft according to the rolling and going direction of the second massage roller rotated by the second supporting shaft and the movement of the handle cause an angle deviation.

8. The device according to claim 2, wherein the supporting body further comprises an elastic pressing member that provides elastic force in a direction inclined at an angle less than 180° in the skin contacting direction, whereby the first massage roller of the first roller supporter and the second massage of the second roller supporter by the elastic force of the elastic pressing member while each supporting body is in close contact with the skin by the pressing force of the first pressurizing supporter and the second pressurizing supporter upon skin contact.

9. The device according to claim 2, wherein the first supporting shaft protruding to one side of the first massage roller is fixed to a first fixing bearing provided on one side of the first roller supporter, and the first massage roller is configured to be rotatable by the first supporting shaft,
the second supporting shaft protruding to one side of the second massage roller is fixed to a second fixing bearing provided on one side of the second roller supporter, and the second massage roller is configured to be rotatable by the second supporting shaft,
the first massage roller, including the first supporting shaft and the first roller cap fixed to cover the first supporting shaft, the first supporting shaft is configured to be rotatable so that the first roller cap is configured to rotate, and
the second massage roller includes a second supporting shaft and a second roller cap fixed to cover the second supporting shaft, so that the second supporting shaft is configured to be rotatable so that the second roller cap is configured to rotate.

10. The device according to claim 9, wherein the first supporting shaft comprises:
a shaft member that becomes the center of rotation of the first massage roller and has one end coupled to and fixed to the first fixing bearing, and is fitted to the shaft member and coupled to the first roller cap to rotate to the shaft member as the first roller cap rotates,
a shroud that rotates with respect to the other end of the shaft member, and
a contact member that contacts the inside of the first roller cap and transmits radio-frequency electricity transmitted through the shaft member to the first roller cap.

11. The device according to claim 10, wherein the contact member comprises a contact base coupled to the end of the shaft member, a spring provided inside the contact base, and a ball contact elastically supported by the spring and contacting the inside of the first roller cap.

12. The device according to claim 1, wherein the pair of massage rollers provided when the first massager and the pair of massage rollers provided by each of the second massagers are in contact with the skin, or when the skin is massaged while rotating according to the movement of the handle in contact with the skin, and
characterized in that to provide the radio-frequency electrical stimulation through a roller, and when the pair of massage rollers do not come into contact with or rotate on the skin, the provision of the radio-frequency electrical stimulation is blocked.

13. The device according to claim 1, wherein at least one of the first massager and the second massager further comprises a rotating detector that detects whether the pair of massage rollers rotate or detects a rotating speed of the rollers, and
the controller provides stimulation and blocks the provision of the radio-frequency electrical stimulation according to the detection of the rotating detector.

14. The device according to claim 1, wherein the first pressurizing supporter and the second pressurizing supporter is provided between the first pressurizing supporter and the second pressurizing supporter and further comprises a pressure detector for detecting whether the opened state, and
the controller provides the radio-frequency electrical stimulation when the first pressurizing supporter and the second pressurizing supporter are broaden for a predetermined time according to the detection result of the pressure detector.

15. The device according to claim 1, further comprising a skin contact detector for detecting whether the pair of massage rollers have come into contact with the skin by sending a preset signal to a pair of massage rollers provided by each of the first massager and the second massager and comparing the signals received from each massage roller with the transmission signal,
wherein the controller provides the radio-frequency electrical stimulation when the state where the pair of massage rollers are in contact with the skin lasts for a predetermined time according to the detection result of the skin contact detector.
